(19) United States
(12) Patent Application Publication
(10) Pub. No.: US 2011/0285584 A1
(43) Pub. Date: Nov. 24, 2011

(54) Handheld Antenna Attitude Measuring System

(76) Inventor: Hendrikus A. Le Sage, Sprang-Capelle (NL)

(21) Appl. No.: 12/947,658

(22) Filed: Nov. 16, 2010

Related U.S. Application Data
(60) Provisional application No. 61/261,459, filed on Nov. 16, 2009.

(51) Int. Cl. G01S 19/42

(52) U.S. Cl. 342/357.25

(57) ABSTRACT

An antenna attitude measuring system includes internal and external electrical components providing data for recording and displaying on a handheld device. The data can be transmitted to a database for access by a network operator. The antenna attitude can be adjusted for maximizing telecommunications network performance.

### CROSS-REFERENCE TO RELATED APPLICATION

This application claims priority in and incorporates by reference U.S. Patent Application Ser. No. 61/261,459, filed Nov. 16, 2009.

### BACKGROUND OF THE INVENTION

1. Field of the Invention

The present invention relates generally to antenna orientation, and in particular to a system for measuring, recording, and transmitting cellular telecommunications antenna attitude.

2. Description of the Related Art

Telecommunication antennas require precise installation and orientation to function efficiently. The physical parameters that affect antenna performance include azimuth, elevation tilt, and slant; together they make up the attitude of an antenna. These parameters are measured manually through use of optical or electrical devices by a site technician when the antenna is installed, during site inspections, and when adjustments to the antenna's attitude are made. Antenna attitude information is important to telecommunications network operators for optimizing network performance, and to site technicians for making manual adjustment to the antenna at a site installation.

Many modern antennas contain electrical components that measure and affect antenna attitude. Such components include electrical sensors and modules that comprise the internal components of an antenna, or external components that attach to the antenna housing in a permanent or temporary manner. Internal components capable of measuring the azimuth, elevational tilt, and slant of the antenna can communicate their readings to network operators through a communications cable attached to the antenna. However, data generated by temporary external components that attach to the antenna for measuring attitude are readable by the site technician in situ but may not otherwise be independently recorded and communicated to a network operator.

What is needed is a system for gathering and recording attitude data generated by the temporary and permanent electrical components of a telecommunications antenna, and for communicating such information to network operators. Heretofore there has not been available an antenna attitude system with the advantages and features of the present invention.

### BRIEF SUMMARY OF THE INVENTION

In a handheld antenna attitude measuring system embodying the principles of the present invention, data from internal and external antenna electrical components are recorded and displayed on a handheld device, and transmitted to a database accessed by a network operator. Accumulating and displaying the data in a handheld device enables a site technician to adjust the attitude of the antenna in real time; transmission and recordation of the data to a separate database enables a network operator to utilize the antenna attitude data to maximize network performance.

### BRIEF DESCRIPTION OF THE DRAWINGS

The drawings constitute a part of this specification and include exemplary embodiments of the present invention illustrating various objects and features thereof, wherein like references are generally numbered alike in the several views.

FIG. 1 is a front elevational view of a handheld antenna measuring system connected to internal and external antenna sensors and modules in accordance with an embodiment of the present invention.

FIG. 2 is an alternative embodiment handheld antenna measuring system in accordance with the present invention.

### DETAILED DESCRIPTION OF THE PREFERRED EMBODIMENT

### I. Introduction and Environment

As required, detailed aspects of the present invention are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. Said terminology will include the words specifically mentioned, derivatives thereof and words of similar meaning.

### II. Preferred Embodiment Attitude Measuring System 2

Referring to the drawings in more detail, the reference numeral 2 generally designates a handheld antenna attitude measuring system embodying aspects of the present invention. The measuring system 2 is shown connected to an antenna 4 and various external electrical devices. The antenna 4 contains internal and external electrical components for measuring antenna attitude that communicate with interface modules located within the measuring system 2. By way of example, a directional panel antenna 4 is shown and described, however, the type of antenna which may be used with the measuring system 2 may include any telecommunications antenna compatible with the Antenna Interface Standards Group (AISG) protocol. In the exemplar embodiment, the antenna 4 is pivotally mounted and releasably attached to a support 5 to enable adjustment of its attitude, and may be located at any distance above the ground.

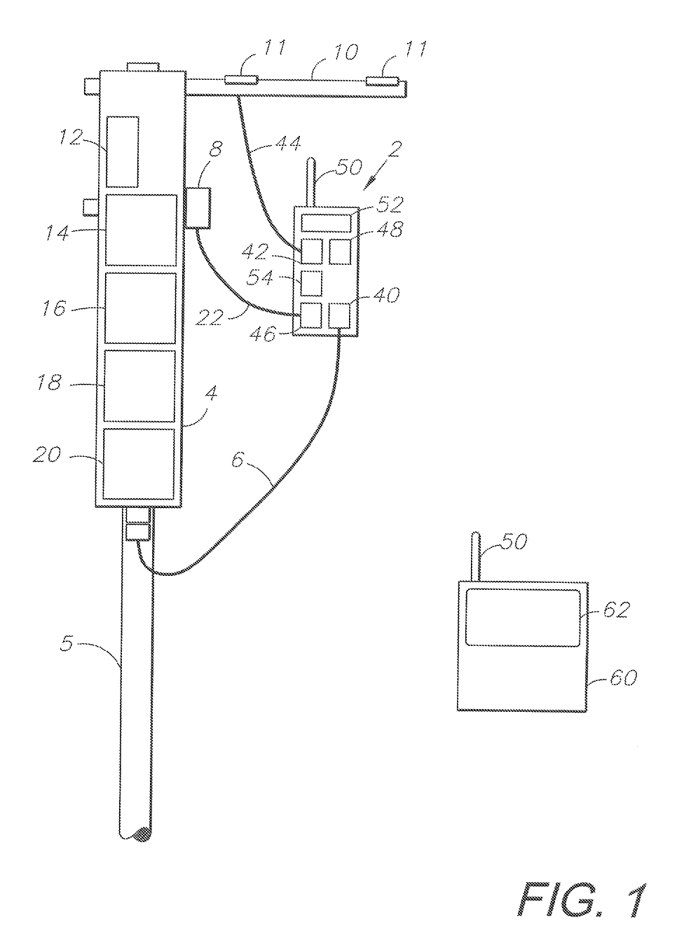

Referring to FIG. 1, the antenna 4 has internal electrical components, such as remote electrical tilt 12, beam control 14, azimuth control 16, and a tilt sensor 18, that either control or monitor functions of the antenna 4. Data generated by the aforementioned components is electrically transmitted between the antenna 4 and measuring system 2 along a communications cable 6 by an AISG antenna interface 20 located within the antenna 4, and an AISG handheld interface 40 located within the measuring system 2. External electrical components such as a Global Positioning System (GPS) azimuth system 10 having GPS receiver dishes 11 for receiving position data from GPS satellites can be releasably attached to the exterior of the antenna 4 for measuring direction and attitude of the antenna 4 using well-known GPS position calculation technology. The GPS azimuth system 10 is connected to, and communicates with, a GPS azimuth module 42 located within the measuring system 2 through a communications cable 44.

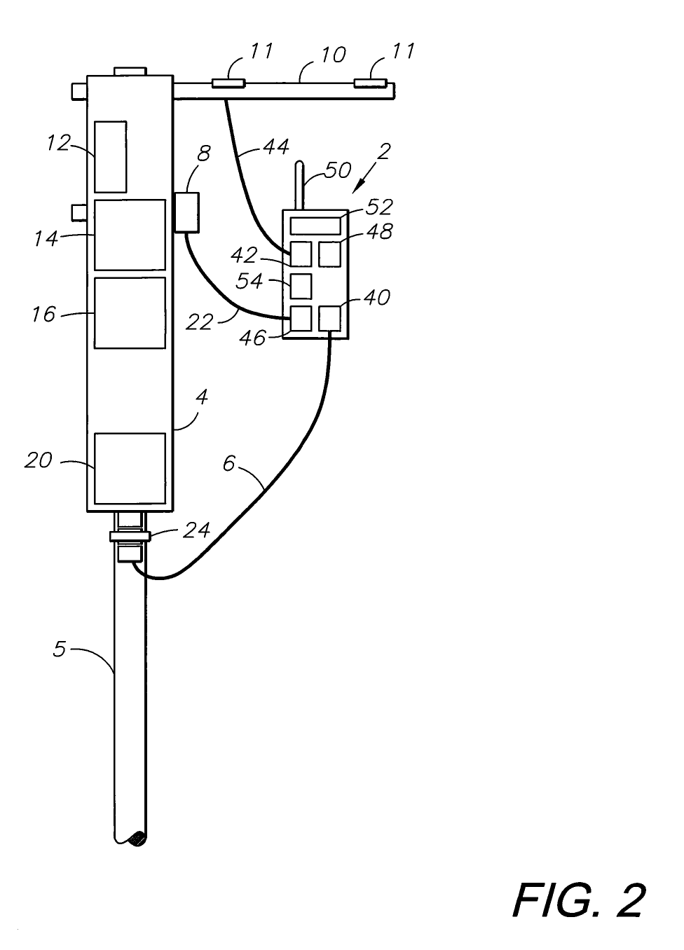

For situations where an antenna does not have an internal tilt sensor 18, an external tilt sensor 8 can be temporarily and releasably mounted, or permanently mounted to the exterior of the antenna 4. An external tilt sensor 8 is connected to, and communicates with a remote tilt sensor module 46 located within the measuring system 2 through a communications cable 22. Alternatively, an AISG compliant in-line tilt sensor 24 can be installed between the antenna 4 and the communications cable 6 (FIG. 2) for transmitting data to the measuring system 2. The measuring system 2 is a modular system, and one skilled in the art will understand it can be expanded to incorporate additional modules for communication with additional electrical components that may be used by a site technician when installing an antenna 4 or when making adjustments to the attitude of the antenna 4.

The measuring system 2 is a handheld, portable electrical device that gathers the antenna attitude data from the internal and external electrical components and stores the data in memory in an encrypted file format. A display 52 graphically represents values from the data generated by the electrical components permitting a site technician to assess the current attitude of the antenna 4 and make adjustments to the orientation of the antenna 4 to optimize network performance. The system 2 uses a communications module 48 to interface with a wired connection, or a wireless connection via an antenna 50 to transmit the data from the system 2 to a computing device 60 having an antenna 50 and a display 62 including, but not limited to, a personal computing device, laptop, personal digital assistant or smart phone. A wireless communications module 54 enables the measuring system 2 to communicate with a database over a mobile telephone system to upload the data received from the electrical components in real time for access by network operators for analysis and interpretation.

It will be appreciated that the components of the measuring system 2 are AISG and Third Generation Partnership Project (3GPP) compliant, and can be used for various other applications. Moreover, the measuring system 2 can be fabricated in various sizes and from a wide range of suitable materials, using various manufacturing and fabrication techniques.

It is to be understood that while certain aspects of the invention have been shown and described, the invention is not limited thereto and encompasses various other embodiments and aspects.

Having thus described the invention, what is claimed as new and desired to be secured by Letters Patent is:

1. A system for measuring telecommunications antenna attitude, which system includes:
an antenna internal tilt component;
an antenna internal beam control component;
an antenna internal azimuth control component;
an antenna internal tilt sensor component; and
an external telecommunications antenna attitude measuring device including an interface connected to the antenna internal components and an output component adapted for providing output corresponding to the attitude of said telecommunications antenna.

2. The system according to claim 1, which includes:
a global navigation satellite system (GNSS) component including a GNSS receiver and a GNSS antenna;
said GNSS antenna being mounted on said telecommunications antenna and connected to said GNSS receiver; and
said GNSS receiver being connected to said interface and adapted for providing a GNSS-based position to said attitude measuring device.
